(19) United States
(12) Patent Application Publication
(10) Pub. No.: US 2018/0137781 A1
(43) Pub. Date: May 17, 2018

(54) SYSTEMS AND METHODS FOR BRAILLE GRADING TOOLS

(71) Applicant: BOARD OF TRUSTEES OF NORTHERN ILLINOIS UNIVERSITY, Dekalb, IL (US)

(72) Inventors: Sean Tikkun, Dekalb, IL (US); Stacy Kelly, Dekalb, IL (US); Rosarin Adulseranee, Dekalb, IL (US)

(21) Appl. No.: 15/807,037

(22) Filed: Nov. 8, 2017

Related U.S. Application Data
(60) Provisional application No. 62/421,600, filed on Nov. 14, 2016.

(51) Int. Cl. G09B 21/00; G06F 17/30; G09B 7/04; G09B 5/04

(52) U.S. Cl. CPC G09B 21/003; G09B 5/04; G09B 7/04; G06F 17/30985

(57) ABSTRACT

The systems and methods described herein provide techniques for grading a submission responsive to a learning prompt, such as that by an automated online braille grading system. The submission is parsed into strings. It is determined that a string does not match an answer string of answer data associated with the learning prompt. One or more errors are identified in the string by performing a character-by-character analysis of the first string. A report indicative of the identified errors in the string and a grading score is generated.

### CROSS REFERENCE TO RELATED APPLICATIONS

This application claims priority from U.S. Ser. No. 62/421,600 filed Nov. 14, 2016, the content of which is herein incorporated by reference in its entirety.

### BACKGROUND

Online learning platforms provide modules that allow users to learn and increase proficiency in various subjects. For example, courses teaching the Braille writing system may include an online component where users may, via an application, complete various modules, such as lesson modules, exercise modules, and testing modules, and receive feedback based on performance of a given module. For instance, an exercise module may prompt a student to translate text to a braille notation (e.g., in ASCII braille format), and resulting feedback is based on whether the submitted answer matches that of the answer key. Generally, online systems for grading braille submissions compare the entire string (or truncated section) of the student submission with the entire string (or truncated section) of the answer key.

After the comparison, a Boolean value of true or false (indicative of whether the string or truncated section matches) is output. However, in the context of grading transcribed materials, such Boolean output typically only provides whether the answer is completely correct. Thus, this form of feedback falls short of providing meaningful feedback. Further, such an approach is made increasingly complex in the case of braille transcription. Literary braille exists as a form of shorthand, and individual characters can represent whole words or strings of multiple characters based on context. A proficient braille transcriber must be capable of identifying these cases of shorthand, even in the middle of a sentence or word, and accurately applying the rules of braille.

### SUMMARY

Techniques are disclosed herein for grading submissions to a platform providing learning modules, e.g., for the Braille writing system. Embodiments may include an automated online Braille grading system that, during the grading process, detects errors made in a given submission and performs a character-by-character analysis to identify one or more characters that are the source of an error. That is, rather than use an exact string match between the string representing an entire answer and the string representing an entire expected answer (such as in other computer-based grading methods conducted over a network), the grading system disclosed herein provides a granular approach for further assessing an error in cases where an submitted string and an expected string do not exactly match.

One embodiment presented herein discloses a method for grading a submission including a plurality of strings responsive to a learning prompt. The method generally includes determining, by execution of one or more processors, that a first string of the submission does not match a first answer string of answer data associated with the learning prompt. The method also generally includes identifying, in response to the determination, one or more errors in the first string by performing a character-by-character analysis on the first string. The method also generally includes generating a report indicative of the identified one or more errors in the first string.

Another embodiment presented herein discloses a computer-readable storage medium storing instructions, which, when executed on a one or more processors, performs an operation for grading a submission including a plurality of strings responsive to a learning prompt. The operation itself generally includes determining, by execution of one or more processors, that a first string of the submission does not match a first answer string of answer data associated with the learning prompt. The operation also generally includes identifying, in response to the determination, one or more errors in the first string by performing a character-by-character analysis on the first string. The operation also generally includes generating a report indicative of the identified one or more errors in the first string.

Yet another embodiment presented herein discloses a system having one or more processors and a memory. The memory stores program code, which, when executed by the one or more processors, performs an operation for grading a submission including a plurality of strings responsive to a learning prompt. The operation itself generally includes determining, by execution of one or more processors, that a first string of the submission does not match a first answer string of answer data associated with the learning prompt. The operation also generally includes identifying, in response to the determination, one or more errors in the first string by performing a character-by-character analysis on the first string. The operation also generally includes generating a report indicative of the identified one or more errors in the first string.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. Note, however, that the appended drawings illustrate only exemplary embodiments and are therefore not to be considered limiting of its scope, and may admit to other equally effective embodiments.

FIG. 1 illustrates an example computing environment;

FIGS. 2A and 2B illustrate example diagrams representative of transcription errors detected in a submission;

FIG. 3 illustrates a simplified block diagram of an environment that may be established by the grading tool described relative to FIG. 1;

FIG. 4 illustrates a simplified flow diagram of a method for grading a submission to a learning platform;

FIG. 5 illustrates a simplified flow diagram of a method for evaluating a submission for error data; and

FIG. 6 illustrates an example computing system providing a learning platform indicative of grading submissions.

To facilitate understanding, identical reference numerals have been used, where possible, to designate identical elements that are common to the figures. Elements and features of one embodiment may be beneficially incorporated in other embodiments without further recitation.

### DETAILED DESCRIPTION

Embodiments presented herein disclose techniques for grading a submission of answers provided in response to a learning prompt and providing relatively meaningful feedback regarding the submitted answers. Input submission data responsive to a given learning prompt is received and parsed into individual answer strings. Each string is compared to a corresponding string in an answer key. If the strings match, then the next string is compared with its corresponding string in the answer key. However, if the strings do not match, an error detection and alignment process is performed on a character-by-character basis on the submitted string. The error detection and alignment process classifies a mismatching character as associated with a given type of error (e.g., a typographical error, an error in contraction, an error in omission, etc.) and re-aligns the character analysis based on the error. Doing so allows the system to identify an answer that a submitting user might have intended and also identify where, in the submitted answer, the user committed the error. Details regarding the error may be recorded to a report and subsequently be made available for access.

For instance, embodiments presented herein may be adapted to an online platform that provides learning modules for the Braille writing system. The platform may include a variety of lesson, exercise, and testing modules aimed at users who are learning how to read and write braille. The Braille writing system generally expresses alphabetic characters using rectangular blocks known as “cells.” A cell is arranged in two columns and three rows that are encoded with dots. Based on the positioning of the dots in the cell, various characters can be expressed, such as letters, numbers, punctuation marks, and words. Because of the amount of configurations that a cell may have, a student of braille can make a variety of errors in transcribing braille. For example, a student intending to write a given character may inadvertently transpose a dot to the opposite row or column, omit a dot, include an extraneous dot, and so on. Likewise, such errors may be reflected in answer submissions to modules in the platform (e.g., in modules that prompt a student to transcribe a sentence to braille).

In an embodiment, the online platform provides a grading tool that automatically evaluates a submission and provides meaningful feedback based on the evaluation. As will be further described, the grading tool detects errors provided in the submission and performs a character-by-character analysis to identify a character that is a source of an error, identify a type of the error, and align the character such that the grading tool can accurately evaluate the following character for errors. That is, rather than using an exact string match between a submitted answer and an expected answer, such as in other computer-based grading methods conducted over a network, the grading tool disclosed herein provides a granular approach for further assessing an error in the event that a submitted answer string and an expected answer string do not exactly match. The grading tool may then generate a report that includes the detected errors and feedback relating to the errors, such as a location of the error in the provided answer, the expected answer, the location of the error in the cell, and the like. The submitting user may access the report to review the errors made and identify techniques for improvement. Doing so potentially reduces the amount of time between a user submitting answers to a learning module and receiving substantive feedback on the submission, compared to a human grader receiving the online-submitted answers and grading the answers manually to provide similar feedback to the user.

In some embodiments, the systems and methods described herein provide an online braille grading system. For example, a Unified English Braille Online Training (UEBOT) lesson may provide students with a practice set of phrases and sentences, to which they will provide answers. The systems and methods automatically grade the practice set to provide students with immediate and accurate feedback. Thus, a student may complete formative practice elements and an automated system provides immediate feedback on the completed practice elements.

In some embodiments, the systems and methods disclosed herein may include an automated braille grading system as a valuable tool to any university programs training pre-service professionals in the field of visual impairments. The large number of courses necessary to properly prepare pre-service professionals in visual impairments places a personnel and credit strain on university programs. When the quality of the systems and methods disclosed herein are established, the resources generated could be utilized by university preparation programs to facilitate more efficient and cohesive instruction of braille content to pre-service professionals.

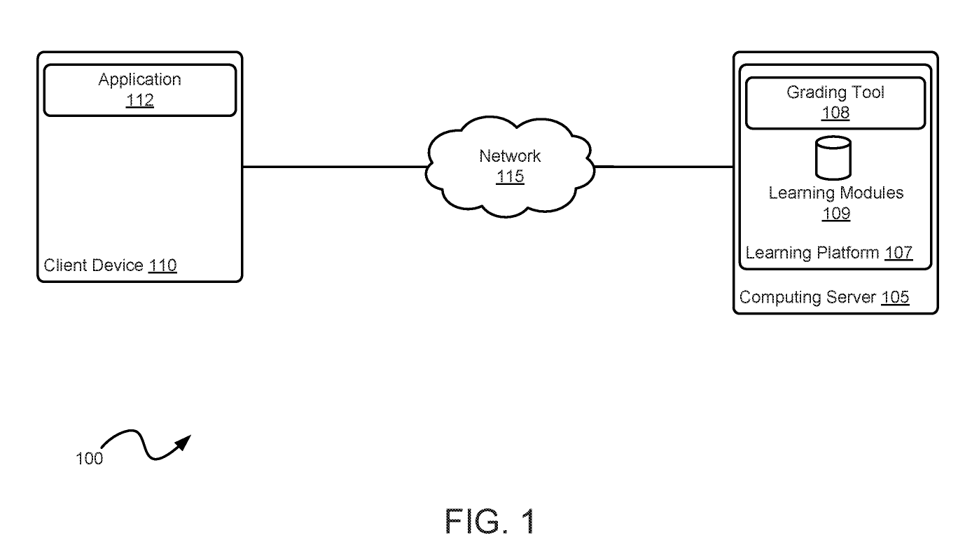

FIG. 1 illustrates an example computing environment 100. As shown, the example computing environment 100 includes a computing server 105 and a client device 110, each interconnected via a network 115. The computing server 105 may be representative of a physical computing system (e.g., a desktop computer, laptop computer, tablet computer, server in a data center, and the like) or a virtual computing instance in a cloud network. While not specifically shown, the computing server 105 may include other computing devices (e.g., servers, mobile computing devices, etc.) which may be in communication with each other and/or the computing server 105 via one or more communication networks (such as the network 115) to perform one or more of the disclosed functions. The client device 110 may be representative of a physical computing system of a virtual computing instance in a cloud network. The network 115 may be embodied as, for example, a cellular network, a local area network, a wide area network (e.g., Wi-Fi), a personal cloud, a virtual personal network (e.g., VPN), an enterprise cloud, a public cloud, an Ethernet network, and/or a public network such as the Internet.

Illustratively, the computing server 105 includes a learning platform 107. The learning platform 107 is an online service that provides training in a variety of areas. For example, the learning platform 107 includes learning modules 109. The learning modules 109 may be embodied as any data indicative of lessons, exercises, tests, and so on, associated with a given subject. Each learning module 109 may include a one or more prompts with which a user may interact, such as short questions that a user must answer with a sufficient score to advance to a next module, essay prompts, multiple choice prompts, and the like. The learning module 109 may be associated with a given subject, such as the Braille writing system. The subject may have an identifier that can be associated with a learning module 109, and further, a learning module 109 may include an identifier distinguishing the module 109 from other modules 109. For example, each identifier may represent a uniquely universal identifier (UUID) (e.g., a 128-bit number produced as a function of the learning module 109 or subject, a timestamp of when the UUID was produced, and a randomly generated number). The learning platform 107 may be representative of a course management system, such as one used by a university. In an embodiment, a learning module 109 may be representative of or be part of a custom module such as the Moodie custom module.

Further, the learning platform 107 provides a communication interface (e.g., an application programming interface (API)) that is accessible by remote devices that allows a user to interact with the learning modules 109. For example, the learning platform 107 may provide the interface to an application 112 executing on the client device 110. The application 112 may be a web browser that accesses the learning platform 107 through the interface. As another example, the application 112 may be a proprietary application that communicates with the learning platform 107 over the network 115 using the API. Further, the application 112 may itself provide a user interface (UI) that allows the learning platform 107 to be accessible by blind and sighted users alike. For example, the UI of the application 112 may be provided using a screen reader, text-to-speech synthesizer, braille display, and the like, for access by blind users. In addition, the UI may display braille text in the form of Braille ASCII.

Note, FIG. 1 depicts merely an example configuration of the learning platform 107 and grading tool 108. However, one of skill in the art will recognize that the grading tool 108 may be implemented in a variety of configurations. In an embodiment, the grading tool 108 may be provided as a plug-in to the learning platform 107. For example, the grading tool 108 may communicate with the learning tool 107 using API functions. The grading tool 108 may also be implemented as a standalone application. Further, although FIG. 1 depicts the learning platform 107 and grading tool 108 as residing on the same host, the grading tool 108 may execute from a host separate from that of the learning platform 107. Further still, in some cases, the learning platform 107 and grading tool 108 may be provided directly to user, e.g., on the client device 110, such as a mobile app.

As stated, the learning modules 109 may include learning prompts (e.g., a braille transcription/translation exercise) targeted to a user that may include questions or other prompts for the user to answer. For example, a given learning prompt may include a number of problems for the user to answer, such as sentences presented in text (or audio) for transcribing into braille. The user may then submit the answers to the learning prompt to the learning platform 107 for grading.

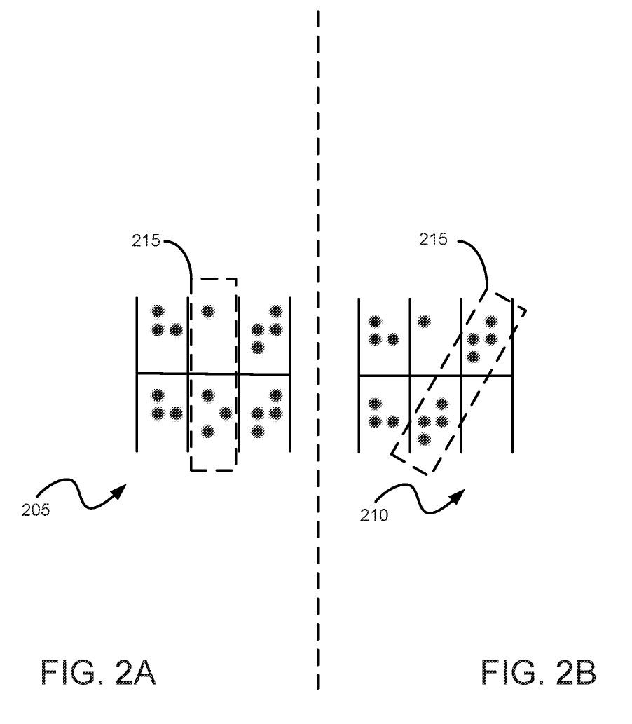

For subjects such as the Braille writing system, errors that are relatively distinct to Braille are present and can necessitate more careful evaluation when grading. For instance, referring now to FIGS. 2A and 2B, errors in Braille transcription can be made by a user inputting braille text to the learning tool 107. In particular, FIGS. 2A and 2B depict non-limiting examples of two errors that can be made for a written braille representation of the word “hat”, as shown on the top row of errors 205 and 210.

In FIG. 2A, error 205 depicts a typographical error, where there is a mismatch 215 between characters. In particular, the mismatch 215 occurs in the second character, where the braille character representing the letter “a” is instead represented by the braille letter “o” in the bottom row, thus resulting in the word “hot” instead of “hat”. In FIG. 2B, error 210 depicts an omission error 220, where the second character on the top row does not match the second character in the bottom row due to an omission of a character (here, the letter “a”), so the bottom row represents “ht” and not “hat”.

Although the above describes relatively simple examples of errors that occur, other, more complex types of errors can occur that are often associated with learning the Braille writing system. For instance, Braille is an expressive writing system where a given character can hold multiple meanings based on context. To achieve this, specialized abbreviations (“contractions”) may be applied to a braille cell. However, as a result, the potential for error can increase. For example, an extra contraction error might involve several characters being missing in a series of student strings as a result of an inappropriate braille contraction (e.g., a single character that represents several characters in specific circumstances). As another example, a missing contraction error might involve a single character (e.g., a contraction) being included in word(s) that represent a series of characters. Other types of errors are discussed further herein.

In an embodiment, the grading tool 108 receives submissions responsive to the learning prompts. As will be further described, the grading tool 108 evaluates the submissions on a character-by-character basis. During the character-by-character evaluation, the grading tool 108 identifies transcription errors, such as whether the error corresponds to a typographical error or an error in contraction, and aligns the characters based on the error. Further, the grading tool 108 provides substantive feedback based on the evaluations. For example, the grading tool 108 generates a report that includes detailed feedback on errors detected in a user submission.

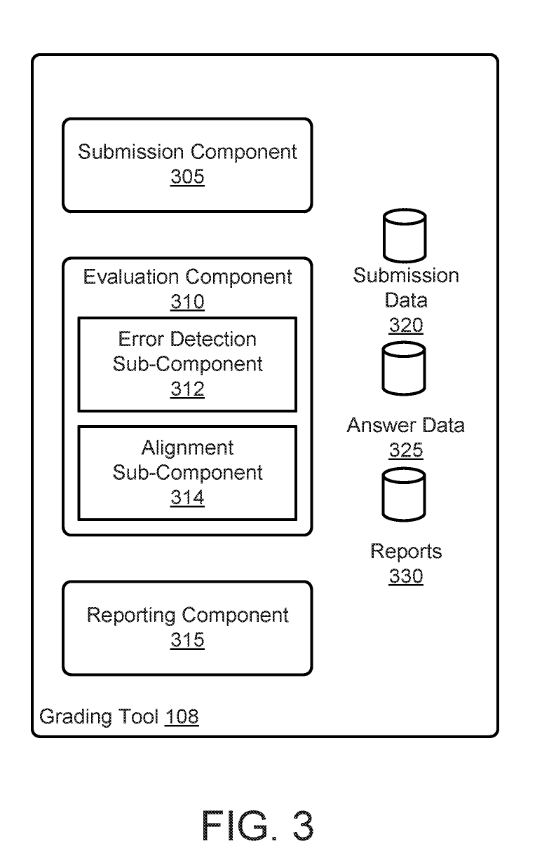

FIG. 3 further illustrates the grading tool 108 described relative to FIG. 1, according to one embodiment. In particular, FIG. 3 represents a conceptual diagram of the process steps performed by the grading tool 108. One of skill in the art will recognize that an actual allocation of process steps may, in practice, vary substantially from this illustration. As shown, the grading tool 108 includes a submission component 305, an evaluation component 310, a reporting component 315, submission data 320, and answer data 325.

In an embodiment, the submission component 305 receives submitted answer files (e.g., submission data 320) from a user, such as from client device 110. The submission data 320 may be embodied as any data representative of answers responsive to a prompt associated with a given learning module 109, such as one or more braille transcriptions. For example, the submission data 320 may include user answers in an ASCII-based formatted file, such as Braille Ready Format (BRF). The file may provide the answers as comma-separated values, and the like. In an embodiment, the client device 110, via the application 112, may encapsulate the submission data 320 in one or more network packets and transmit the network packets containing the submission data 320 to the submission component 305. In turn, the submission component 305 may evaluate identifiers included with the submission data 320 and associate the submission data 320 with corresponding answer data 325.

The answer data 325 may be embodied as any data indicative of answer keys associated with a given learning module 109. The answer data 325 may be provided as an ASCII-based formatted file, such as BRF, with the answers provided as comma-separated values. Of course, other formats may be contemplated (e.g., spreadsheet format, etc.). Further, given answer data 325 may include an identifier (e.g., a UUID) associated with a particular learning module 109, which allows the submission component 305 to associate a particular submission data 320 with corresponding answer data 325.

In an embodiment, the evaluation component 210 assesses submission data 320 against a corresponding answer data 325. To do so, the evaluation component 210 may identify the corresponding answer data 325, e.g., by performing a lookup of the answer data 325 by the UUID provided by the submission data 320. Further, the evaluation component 210 parses the submission data 320 to individual strings, each string corresponding to an answer responsive to a prompt in an associated module. Doing so allows the evaluation component 210 to perform an analysis on each string relative to an expected corresponding answer string provided by the answer data 325.

Illustratively, the evaluation component 210 includes an error detection sub-component 312 and an alignment sub-component 314. In an embodiment, the error detection sub-component 312 may perform string comparison techniques between a string in the submission data 320 and a corresponding string in the answer data 325, representative of an expected answer. If the strings do not match, the error detection sub-component 312 may perform further analysis on a character-by-character basis to determine a type of error associated with one or more characters in the string.

For example, as discussed above, typographical errors, omission errors, extra contraction errors, and missing contraction errors are types of errors that may occur in a given character. Another example of an error type may include an extra character error. To assess an extra character error, the error detection sub-component 312 might identify a mismatch between a submission string character and an expected character in the answer data 325 and subsequently identify the expected character in the following character of the submission string. As another example, the error detection sub-component 312 may identify an extra space error, which involves encountering a blank space in a submitted string that should not belong in the string. As yet another example, the error detection sub-component 312 may detect a reversal error, where a dot configuration in the submission string character representing a cell is a mirror reversal of the dot configuration in the expected character representing a cell in the answer data 325. In an embodiment, the answer data 325 may include reversal data that the error detection sub-component 312 may query to determine the likelihood that a particular character is a reversal for a character in a given answer string.

In cases where the error detection sub-component 312 identifies an error while analyzing a given character, the alignment sub-component 314 re-aligns the analysis of the submission and answer strings such that further comparisons can be made between characters of both strings. For example, as part of realignment, the alignment sub-component 314 may, for an extra space error, advance to the next character (if any) in the submission string. As another example, for a typographical error, the alignment sub-component 314 advances to the next characters in both the submission string and answer string to determine whether a match is present, and if so, the alignment sub-component 314 advances to the next characters. As yet another example, for an extra character error, the alignment sub-component 314 compares the next character in the submission string to the presently evaluated character in the answer string. If a match is present, then the alignment sub-component 314 advances the submission string to the next character. Still as another example, for an extra contraction error, the alignment sub-component 314 advances character-by-character in the submission string until a match is present, in which case the alignment sub-component 314 sets the current character in the submission string to that character position. Even still as an another example, for a missing contraction error, the alignment sub-component 314 advances the character in the answer string until there is a match with the current character in the submission string, in which case the alignment sub-component 314 sets the current character in the answer string in that position. As another example, for a reversal error, the alignment sub-component 314 advances to the next character in each of the submission string and the answer string. The evaluation component 310 analyzes each character of the submission string until reaching the end of the string.

In an embodiment, the evaluation component 310 further records information detailing each identified error and alignment. For example, information associated with a given identified error may include the associated module, the prompt number, line, and cell (cardinal character location in line), type of error, expected answer, and the like.

The reporting component 315 generates a report 330 detailing errors identified in submission data 320 by the evaluation component 310. To do so, the reporting component 315 may create a report 330 and populate the report 330 with the information recorded by the evaluation component 310. In an embodiment, the report 330 may be a mark-up language file (e.g., an XML file, HTML file, JSON file, etc.) that can be presented on the UI by the application 112. In other embodiments, the report 330 may be a plaintext file, spreadsheet file, word processor document, and the like.

Further, the reporting component 315 provides users access to download submission data 320, reports 330, other reports, or other information. In some embodiments, students and teachers may have varying access to the data such that students can only access their own information while teachers can access all their students' information. In other words, the reporting component 315 may assign various access privileges to a given user based on their role (e.g., whether the user is an administrator, instructor, student, auditor, etc.). The submission data 320, answer data 325, and reports 330 and the like may be stored in a data store, e.g., a database, networked file server, and the like. In some embodiments, the reporting component 315 may also generate analytics based on an aggregate of error data. For example, the reporting component 315 may aggregate error data of a given user, which allows the reporting component 315 to identify areas throughout various modules where a user tends to en. As another example, the reporting component 315 may aggregate error data of a group of users, which allows the reporting component 315 to identify different areas where user errors converge, areas where user errors diverge, historical trends, etc. The reporting component 315 may make such information available via the UI on the application 112, or through a downloadable file.

In some embodiments, the reporting component 315 offers fast feedback on number of errors and location. This grading tool 108 may attempt to predict and plan for expected errors through pilot work. Over time, the reporting component 315 may address emerging, common, and/or novel errors that students make (e.g., via the pilot work, aggregated data, etc.). Advantageously, automating what used to be an extremely time intensive process (e.g., where an instructor might need 10-15 hours to accurately grade a module completed by an entire class of students), instructors are able to focus increasingly on other student concerns and needs.

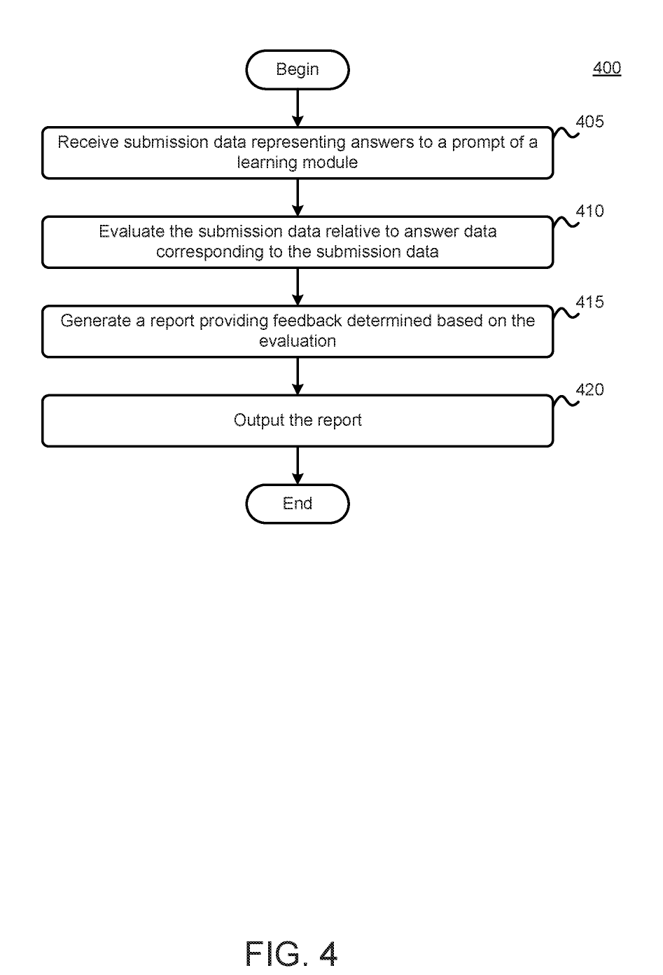

FIG. 4 illustrates a simplified flow diagram of a method 400 for grading a submission to the learning platform 107 by the grading tool 108, according to one embodiment. As shown, method 400 begins at step 405, where the submission component 305 receives submission data representing answers to a prompt of a learning module. As stated, the submission data may be received from a client device 110 (or any other device suitable for sending such submission data to the learning platform 107).

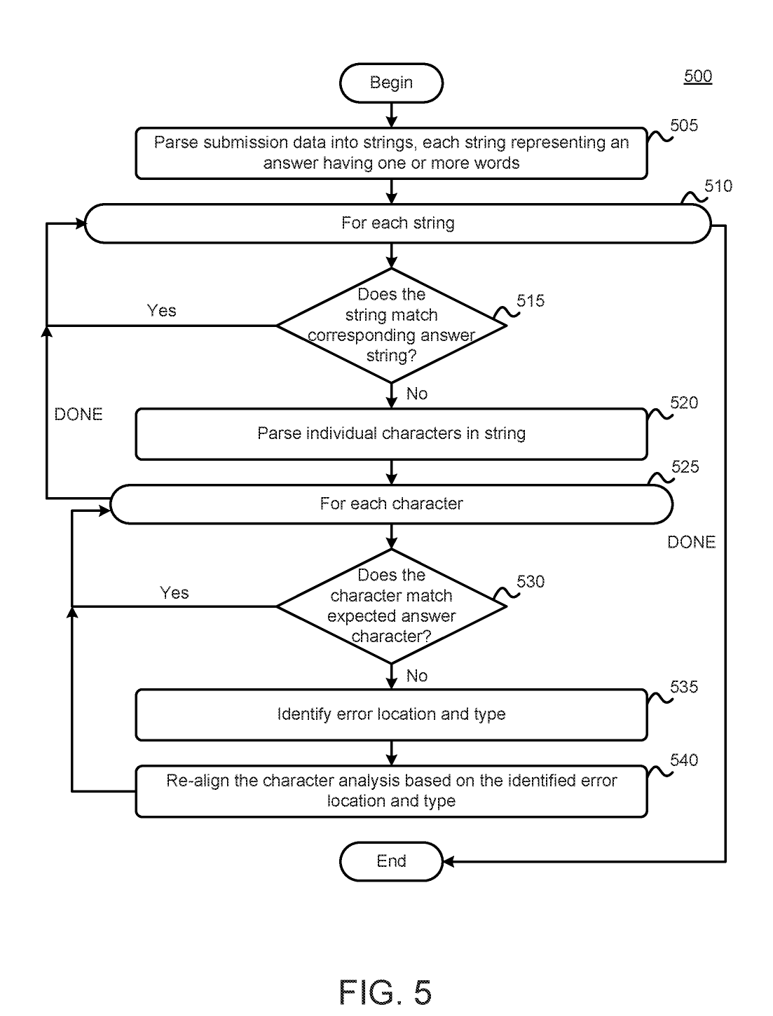

At step 410, the evaluation component 310 analyzes the submission data relative to answer data corresponding to the submission data. More specifically, the evaluation component 310 parses each string and conducts a character-by-character analysis of the string in the event that a complete string mismatch occurs. This process is described in further detail relative to FIG. 5. Once complete, the evaluation component 310 may return results of the analysis (e.g., reports describing error data and other analytics) to the reporting component 315. Further, the grading component 310 may access an overall grading score of the submission based on correct answers, partially correct answers (e.g., submitted answers associated with one or more errors), and incorrect answers (e.g., submitted answers associated with one or more errors).

At step 415, the reporting component 315 generates a report providing feedback determined based on the evaluation. For example, the reporting component 315 may create a new instance of a file formatted to contain a report and populate that file with the identified error data and other analytics. At step 420, the reporting component 315 outputs the report. For example, the reporting component 315 may transmit the report directly to the submitting client device 110 over the network 115, or the reporting component 315 may make the file available for download on a data store, such as a database or a file server.

FIG. 5 illustrates a simplified flow diagram of a method 500 for evaluating a submission for error data, according to one embodiment. As shown, the method 500 begins at step 505, where the error detection sub-component 312 parses the submission data into strings. Each string represents an answer to the learning prompt, where the answer can have one or more words.

At step 510, the method 500 enters a loop for each string parsed by the error detection sub-component 312. At step 515, the error detection sub-component 312 determines whether the string matches a corresponding answer string. If so, then the method 500 continues onto the next string as part of the loop of step 510.

Otherwise, if not, then at step 520, the error detection sub-component 312 parses individual characters of the string. The method 500 enters a sub-loop for each character at step 525. At step 530, the error detection sub-component 312 determines whether the character matches an expected answer character. If so, then the method 500 continues analyzing the next character at the sub-loop of step 525. If not, then at step 535, the error detection sub-component 312 identifies an error location and type. For instance, the error detection sub-component 312 may identify whether the mismatch occurs as a result of error types, such as the following non-limiting examples: (i) extra space, (ii) typo, (iii) omission, (iv) extra character, (v) extra contraction, (vi) miss contraction, and (vii) reversal. In addition, the error-detection sub-component 312 may record the identified error location and type. The error-detection sub-component may also record other information, e.g., module number, line, and cell (cardinal character location in the line).

At step 540, the alignment sub-component 314 re-aligns the character analysis based on the identified error location and type. Examples of the various alignment processes based on error type are discussed above relative to FIG. 3. The method 500 continues through the sub-loop until each character of the string has been evaluated. Further, the method 500 continues through the loop until each string is evaluated. At completion of the method 500, the evaluation component 310 may return the evaluated data to the reporting component 315.

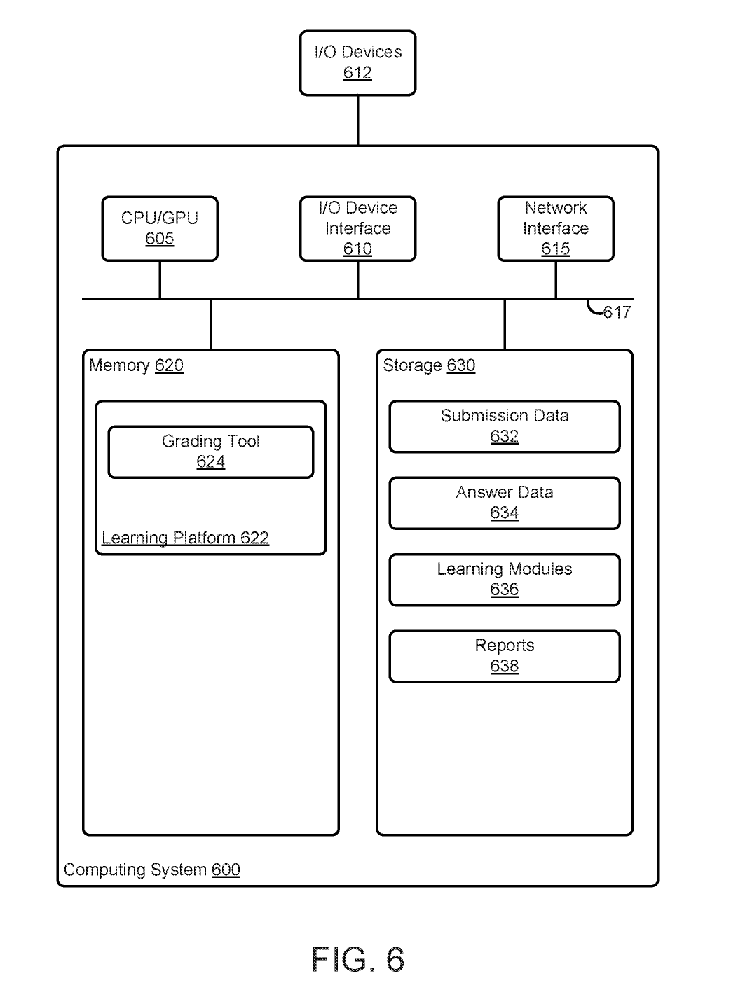

FIG. 6 illustrates an example computing system 600 providing a learning platform indicative of grading submissions, according to one embodiment. As shown, the computing system 600 includes, without limitation, one or more central processing units (CPUs) 605, a network interface 615, a memory 620, and storage 630, each interconnected with a bus 617. The computing system 600 may also include an I/O device interface 610 connecting I/O devices 612 (e.g., keyboard, display, mouse devices, etc.) to the computing system 600. Further, in context of the present disclosure, the computing elements shown in the computing system 600 may correspond to a physical computing system (e.g., a desktop computer, laptop computer, smart phone, tablet computer, enterprise computing system, etc.) or virtual computing instance.

CPU 605 retrieves and executes program code stored in memory 620 as well as stores and retrieves application data residing in the storage 630. The bus 617 is used to transmit programming instructions and application data between CPU 605, I/O devices interface 610, storage 630, network interface 615, and memory 620. Note, CPU 605 is included to be representative of a single CPU, multiple CPUs, a single CPU having multiple processing cores, and the like. Memory 620 is generally included to be representative of any suitable computer memory device (e.g., volatile memory such as various forms of random access memory). Storage 630 may be a disk drive storage device. Although shown as a single unit, storage 630 may be a combination of fixed and/or removable storage devices, such as fixed disc drives, removable memory cards, or optical storage, network attached storage (NAS), flash memory, memory cards, memory sticks, or a storage area-network (SAN). The network interface 615 may, alternatively or additionally, enable shorter-range wireless communications between the computing system 600 and other computing devices, using, for example, Bluetooth and/or Near Field Communication (NFC) technology. Accordingly, the network interface 615 may include one or more optical, wired, and/or wireless network interface subsystems, cards, adapters, or other devices, as may be needed pursuant to the specifications and/or design of the particular computing system 600.

Illustratively, the memory 620 includes a learning platform 622, which itself includes a grading tool 624. The storage 630 includes submission data 632, answer data 634, learning modules 636, and reports 638. The learning platform 622 provides lesson modules, exercise modules, and testing modules (e.g., learning modules 636) relating to a subject, such as the Braille writing system. A given module may provide various prompts to which a user can submit answers. In an embodiment, the grading tool 624 is configured to determine whether a string in a submission (provided as submission data 632) matches a corresponding answer string (provided as answer data 634). The grading tool 624 further identifies, in response to a determination that the submission string and the answer string do not match, one or more errors based on a character-by-character analysis of the submission string. In particular, the grading tool 624 determines whether a given character in the string matches an expected character from the corresponding answer string. If not, then the grading tool 624 determines the type of error, such as whether the error corresponds to a typographical error, an error in transposition, an extra character, and the like. Based on the type of error, the grading tool 624 aligns the character and evaluates the next character similarly until each character has been evaluated. The grading tool 624 generates a report 638 indicative of the errors detected in the evaluation. The report 638 may include information regarding each error, such as the location in the module where the error was made, the character(s) involved with the error, a type of the error, etc. Once generated, the grading tool 624 makes the report 638 available, e.g., by transmitting the report over a network to a client device, uploading the report to a file server for download, and the like.

In the preceding description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration only, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more computer-readable storage media which may be read and executed by one or more processors. A machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided in sub-modules, sub-processes or other units of computer code or data as may be required by a particular design or implementation of the computing device.

In the drawings, specific arrangements or orderings of elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships, or associations between elements may be simplified or not shown in the drawings so as not to obscure the disclosure.

This disclosure is considered to be exemplary and not restrictive. In character, and all changes and modifications that come within the spirit of the disclosure are desired to be protected. While particular aspects and embodiments are disclosed herein, other aspects and embodiments will be apparent to those skilled in the art in view of the foregoing teaching.

What is claimed is:

1. A computer-implemented method for grading a submission including a plurality of strings responsive to a learning prompt, the method comprising:
determining, by execution of one or more processors, that a first string of the submission does not match a first answer string of answer data associated with the learning prompt;
identifying, in response to the determination, one or more errors in the first string by performing a character-by-character analysis on the first string; and
generating a report indicative of the identified one or more errors in the first string.

2. The computer-implemented method of claim 1, wherein the character-by-character analysis comprises:
identifying at least a first character in the first string that does not match an expected character in the first answer string; and
determining an error type based on the identified first character;

3. The computer-implemented method of claim 2, wherein the error type is one of at least an extra space error, a typographical error, an error in omission, an extra character error, an extra contraction error, a missing contraction error, and a reversal error.

4. The computer-implemented method of claim 2, wherein the character-by-character analysis further comprises:
aligning the first character with the expected character based on the determined error type.

5. The computer-implemented method of claim 4, wherein generating the report comprises:
populating the report with the identified one or more errors, the determined error type, and a location of the error in the submission.

6. The computer-implemented method of claim 1, wherein the learning prompt is a braille transcription exercise, and wherein the submission is a braille transcription.

7. The computer-implemented method of claim 1, further comprising:
assessing an overall score for the submission based in part on the identified one or more errors.

8. The computer-implemented method of claim 1, further comprising:
assigning one or more access privileges to the report.

9. The computer-implemented method of claim 1, further comprising:
receiving the submission; and
parsing the submission into the plurality of strings.

10. A computer-readable storage medium storing instructions, which, when executed on one or more processors, performs an operation for grading a submission including a plurality of strings responsive to a learning prompt, the operation comprising:
determining, by execution of one or more processors, that a first string of the submission does not match a first answer string of answer data associated with the learning prompt;
identifying, in response to the determination, one or more errors in the first string by performing a character-by-character analysis on the first string; and
generating a report indicative of the identified one or more errors in the first string.

11. The computer-readable storage medium of claim 10, wherein the character-by-character analysis comprises:
identifying at least a first character in the first string that does not match an expected character in the first answer string;
determining an error type based on the identified first character, wherein the error type is one of at least an extra space error, a typographical error, an error in omission, an extra character error, an extra contraction error, a missing contraction error, and a reversal error; and
aligning the first character with the expected character based on the determined error type.

12. The computer-readable storage medium of claim 11, wherein generating the report comprises:
populating the report with the identified one or more errors, the determined error type, and a location of the error in the submission.

13. The computer-readable storage medium of claim 10, wherein the learning prompt is a braille transcription exercise, and wherein the submission is a braille transcription.

14. The computer-readable storage medium of claim 10, wherein the operation further comprises:
assessing an overall score for the submission based in part on the identified one or more errors.

15. The computer-readable storage medium of claim 10, wherein the operation further comprises:
assigning one or more access privileges to the report.

16. The computer-readable storage medium of claim 10, wherein the operation further comprises:
receiving the submission; and
parsing the submission into the plurality of strings.

17. A system, comprising:
one or more processors; and
a memory storing program code, which, when executed on the processor, performs an operation for grading a submission including a plurality of strings responsive to a learning prompt, the operation comprising:
determining, by execution of one or more processors, that a first string of the submission does not match a first answer string of answer data associated with the learning prompt,
identifying, in response to the determination, one or more errors in the first string by performing a character-by-character analysis on the first string. and
generating a report indicative of the identified one or more errors in the first string.

18. The system of claim 17, wherein the character-by-character analysis comprises:
identifying at least a first character in the first string that does not match an expected character in the first answer string; and
determining an error type based on the identified first character;

19. The system of claim 18, wherein the error type is one of at least an extra space error, a typographical error, an error in omission, an extra character error, an extra contraction error, a missing contraction error, and a reversal error.

20. The system of claim 18, wherein the character-by-character analysis further comprises:
aligning the first character with the expected character based on the determined error type.

21. The system of claim 20, wherein generating the report comprises:
populating the report with the identified one or more errors, the determined error type, and a location of the error in the submission.

22. The system of claim 17, wherein the learning prompt is a braille transcription exercise, and wherein the submission is a braille transcription.

23. The system of claim 17, wherein the operation further comprises:
assessing an overall score for the submission based in part on the identified one or more errors.

24. The system of claim 17, wherein the operation further comprises:
assigning one or more access privileges to the report.

25. The system of claim 17, wherein the operation further comprises:
receiving the submission; and
parsing the submission into the plurality of strings.
